(19) United States
(12) Patent Application Publication
(10) Pub. No.: US 2026/0302384 A1
(43) Pub. Date: Oct. 1, 2026

(54) ALL-SOLID-STATE BATTERY

(71) Applicant: HONDA MOTOR CO., LTD., Tokyo (JP)

(72) Inventors: Mitsuhiro Sada, Wako-shi (JP); Kiyoshi Tanaami, Wako-shi (JP); Shoji Takahashi, Wako-shi (JP)

(21) Appl. No.: 19/549,022

(22) Filed: Feb. 25, 2026

(30) Foreign Application Priority Data
Mar. 25, 2025 (JP) 2025-049396

(51) Int. Cl. H01M 10/42; H01M 10/0525; H01M 10/056; H01M 50/443; H01M 50/446; H01M 50/457; H01M 50/474

(52) U.S. Cl. CPC H01M 10/4235; H01M 10/0525; H01M 10/056; H01M 50/443; H01M 50/446; H01M 50/457; H01M 50/474; H01M 2300/0094

(57) ABSTRACT

An all-solid-state battery includes a positive electrode layer, a negative electrode layer, a solid electrolyte layer disposed between the positive electrode layer and the negative electrode layer, and an insulating layer disposed on an outer periphery of the positive electrode layer. The solid electrolyte layer includes the inner layer portion disposed inside the boundary between the outer periphery of the positive electrode layer and the insulating layer in plan view, and the outer layer portion disposed on the outer periphery of the inner layer portion in plan view and overlapping the insulating layer. The outer layer portion has a lower ionic conductivity than the inner layer portion.

### CROSS-REFERENCE TO RELATED APPLICATIONS

This application is based on and claims the benefit of priority from Japanese Patent Application No. 2025-049396 filed in Japan on Mar. 25, 2025, the contents of which are hereby incorporated by reference in their entirety.

### BACKGROUND OF THE INVENTION

### Field of the Invention

The present invention relates to an all-solid-state battery.

### Description of Related Art

In recent years, research and development on batteries that contribute to energy efficiency have been conducted so that more people are able to access affordable, reliable, sustainable, and advanced energy. For example, an all-solid-state battery has been developed as a battery. An all-solid-state battery includes a positive electrode layer, a negative electrode layer, and a solid electrolyte layer disposed between the positive electrode layer and the negative electrode layer. For example, an all-solid-state lithium-ion secondary battery includes a solid electrolyte mainly constituted of an ion conductor capable of ion conduction in a solid. In the all-solid-state lithium-ion secondary battery, a problem (a problem caused by a combustible organic electrolytic solution) that occurs in a liquid system lithium-ion secondary battery does not occur. The all-solid-state lithium-ion secondary battery can greatly improve power density and energy density of the battery by using a positive electrode material having a high potential and a large capacity and a negative electrode material having a large capacity.

United States Patent No. 2023/0207886 discloses an all-solid-state battery in which precipitation due to non-uniform growth of lithium (Li) is prevented to improve durability. The all-solid-state battery disclosed in United States Patent No. 2023/0207886 includes an anode layer, a solid electrolyte layer disposed on the anode layer, a cathode layer disposed on the solid electrolyte layer, and an edge portion disposed on an upper surface of the anode layer and in contact with a side surface of the solid electrolyte layer.

On the other hand, an all-solid-state battery including an insulating layer (an insulating frame) disposed on an outer periphery of a positive electrode layer in order to improve insulation is known.

### SUMMARY OF THE INVENTION

In the constitution including the insulating layer (the insulating frame) disposed on the outer periphery of the positive electrode layer, in a vicinity of an end portion of the positive electrode layer, the thickness of the negative electrode layer may be larger and the thickness of the solid electrolyte layer may be smaller than those in a central portion (an inner side in a plane direction orthogonal to a lamination direction). In this case, the vicinity of the boundary between the outer periphery of the positive electrode layer and the insulating layer has a lower resistance than a periphery and tends to allow a current to pass therethrough, so that a reaction variation occurs. In the vicinity of the above boundary, since the thickness of the solid electrolyte layer is smaller than the periphery, the density becomes high, ionic conductivity is high, the current is concentrated more than other regions, and the deterioration is accelerated. In the deterioration acceleration portion, cycle characteristics may be deteriorated. Therefore, it is desired to suppress the deterioration of the cycle characteristics.

In order to solve the above problem, an object of the present application is to suppress deterioration of cycle characteristics. Consequently, the present application contributes to energy efficiency.

As a means for solving the above problem, according to an aspect of the present invention, following constitutions are included.
(1) An all-solid-state battery according to an aspect of the present invention (for example, an all-solid-state battery 1 according to an embodiment) includes: a positive electrode layer (for example, a positive electrode layer 2 in the embodiment); a negative electrode layer (for example, a negative electrode layer 3 in the embodiment); a solid electrolyte layer (for example, a solid electrolyte layer 4 in the embodiment) disposed between the positive electrode layer and the negative electrode layer; and an insulating layer (for example, an insulating layer 5 in the embodiment) disposed on an outer periphery of the positive electrode layer, wherein the solid electrolyte layer includes: an inner layer portion (for example, an inner layer portion 41 in the embodiment) disposed inside a boundary (for example, a boundary 40 in the embodiment) between the outer periphery of the positive electrode layer and the insulating layer in plan view; and an outer layer portion (for example, an outer layer portion 42 in the embodiment) disposed on an outer periphery of the inner layer portion in the plan view and overlapping the insulating layer, and the outer layer portion has a lower ionic conductivity than the inner layer portion.

According to this constitution, in the constitution in which the insulating layer is provided on the outer periphery of the positive electrode layer, since the ionic conductivity of the outer layer portion of the solid electrolyte layer is lower than that of the inner layer portion, it is possible to suppress reaction variation (in-plane resistance variation) in the vicinity of the boundary between the outer periphery of the positive electrode layer and the insulating layer. That is, by controlling the ion conductivity of an outer side portion of the solid electrolyte layer, rate characteristics of an entire cell reaction surface can be equalized, and current concentration can be suppressed. Therefore, deterioration of cycle characteristics can be suppressed. Consequently, the present invention contributes to energy efficiency.
(2) In the all-solid-state battery according to (1), the insulating layer may have an inclination (for example, an inclination 5a in the embodiment) such that the thickness becomes smaller toward an outside from the boundary.

According to this constitution, since the insulating layer is inclined so as to be lowered toward an outer end portion, a density of the outer layer portion after pressing becomes low. The outer layer portion is formed of a same material as a material of the solid electrolyte layer, and after pressing, the thickness becomes larger toward an outer end side than that before pressing, so that the density decreases. The positive electrode layer and the insulating layer are different from each other in physical properties (for example, mechanical properties). Even in consideration of disposing the solid electrolyte layer on each of the layers and pressing the solid electrolyte layer, the outer layer portion has a lower density toward the outer end side as the insulating layer is inclined so as to be lower toward the outer end portion. As a result, ionic conductivity decreases toward the outer end side of the outer layer portion. Therefore, an electrode reaction outside a positive electrode area (a region outside a portion overlapping the positive electrode layer in plan view, in other words, a region overlapping the outer layer portion in plan view) can be suppressed.
(3) In the all-solid-state battery according to (1) or (2), the outer layer portion may include solid electrolyte particles (for example, solid electrolyte particles 11 in the embodiment) having a particle size larger than that of the inner layer portion.

According to this constitution, in the outer layer portion of the solid electrolyte layer, a contact area between the solid electrolyte particles 11 is reduced, so that the ionic conductivity can be further reduced.
(4) In the all-solid-state battery according to any one of (1) to (3), the solid electrolyte layer may contain a binder (for example, a binder 12 in the embodiment), and the outer layer portion may have a larger amount of the binder than the inner layer portion.

According to this constitution, as compared with a case where the amount of the binder in the outer layer portion is smaller than that in the inner layer portion, the ionic conductivity can be further reduced and mechanical strength can be improved in the outer layer portion of the solid electrolyte layer.
(5) In the all-solid-state battery according to any one of (1) to (4), the outer layer portion may contain an insulating base material (for example, an insulating base material 13 in the embodiment).

According to this constitution, as compared with a case where the outer layer portion does not contain the insulating base material, in the outer layer portion of the solid electrolyte layer, the ionic conductivity can be further reduced, and the mechanical strength can be improved.
(6) The all-solid-state battery according to any one of (1) to (5) may further include an ion conduction suppressing layer (for example, an ion conduction suppressing layer 6 in the embodiment) that suppresses conduction of ions between the insulating layer and the outer layer portion.

According to this constitution, the ionic conductivity can be further reduced in the outer layer portion of the solid electrolyte layer by the ion conduction suppressing layer.
(7) In the all-solid-state battery according to (2), the outer layer portion may have an inclination (for example, an inclination 42a in the embodiment) such that the thickness of the outer layer portion increases toward the outside from the boundary along the inclination of the insulating layer.

According to this constitution, since the density of the outer layer portion becomes lower toward the outer end side, the ionic conductivity decreases toward the outer end side of the outer layer portion. Therefore, the ionic conductivity can be further reduced in the outer layer portion of the solid electrolyte layer.
(8) In the all-solid-state battery according to (3), the outer layer portion may not contain the solid electrolyte particles having a particle size of 1 μm or less.

According to this constitution, since the solid electrolyte particles contained in the outer layer portion are only coarse particles, the ionic conductivity can be further reduced in the outer layer portion of the solid electrolyte layer.
(9) In the all-solid-state battery according to (4), the amount of the binder in the outer layer portion may be 3 wt % or more relative to a total weight of the solid electrolyte layer, and the amount of the binder in the inner layer portion may be less than 3 wt % relative to the total weight of the solid electrolyte layer.

According to this constitution, in the outer layer portion of the solid electrolyte layer, the ionic conductivity can be further reduced, and the mechanical strength can be improved.
(10) In the all-solid-state battery according to (5), the amount of the insulating base material in the outer layer portion relative to the total weight of the solid electrolyte layer may be 3 wt % or more, and the amount of the insulating base material in the inner layer portion relative to the total weight of the solid electrolyte layer may be less than 3 wt %.

According to this constitution, in the outer layer portion of the solid electrolyte layer, the ionic conductivity can be further reduced, and the mechanical strength can be improved.
(11) In the all-solid-state battery according to (6), the ion conduction suppressing layer may be formed between the insulating layer and the outer layer portion from the boundary to an outer end.

According to this constitution, as compared with a case where the ion conduction suppressing layer is locally formed between the insulating layer and the outer layer portion, the ionic conductivity can be further reduced in the outer layer portion of the solid electrolyte layer.
(12) The all-solid-state battery according to any one of (1) to (11) may further include an intermediate layer (for example, an intermediate layer 7 in the embodiment) containing particles having a particle size of 0.5 μm or less between the solid electrolyte layer and the negative electrode layer.

According to this constitution, even when the thickness of the intermediate layer is small and the particle size of the particles contained in the intermediate layer is small, a structure of the intermediate layer can be stabilized by increasing the density of the solid electrolyte layer.

According to the aspect of the present invention, deterioration of cycle characteristics can be suppressed, and this contributes to improvement of energy efficiency.

### BRIEF DESCRIPTION OF DRAWINGS

FIG. 1 is a plan view illustrating an all-solid-state battery according to an embodiment;

FIG. 2 is a cross-sectional view taken along line II-II of FIG. 1;

FIG. 3 is a cross-sectional view illustrating a first example for suppressing deterioration of cycle characteristics;

FIG. 4 is a cross-sectional view illustrating a second example for suppressing the deterioration of the cycle characteristics;

FIG. 5 is a cross-sectional view illustrating a third example for suppressing the deterioration of the cycle characteristics;

FIG. 6 is a cross-sectional view illustrating a fourth example for suppressing the deterioration of the cycle characteristics;

FIG. 7 is a cross-sectional view illustrating a fifth example for suppressing the deterioration of the cycle characteristics; and

FIG. 8 is a cross-sectional view illustrating an all-solid-state battery according to a comparative example.

### DETAILED DESCRIPTION OF THE INVENTION

Hereinafter, an embodiment of the present invention will be described with reference to the drawings. In the following description, expressions indicating relative or absolute dispositions such as, for example, “parallel”, “orthogonal”, “center”, and “coaxial” not only strictly mean such dispositions but also include a state of being relatively displaced with a tolerance, or an angle or a distance at which the same function is obtainable. In the drawings for use in the following description, the scale of each member is appropriately changed in order to make each member recognizable in size.

### <All-Solid-State Battery>

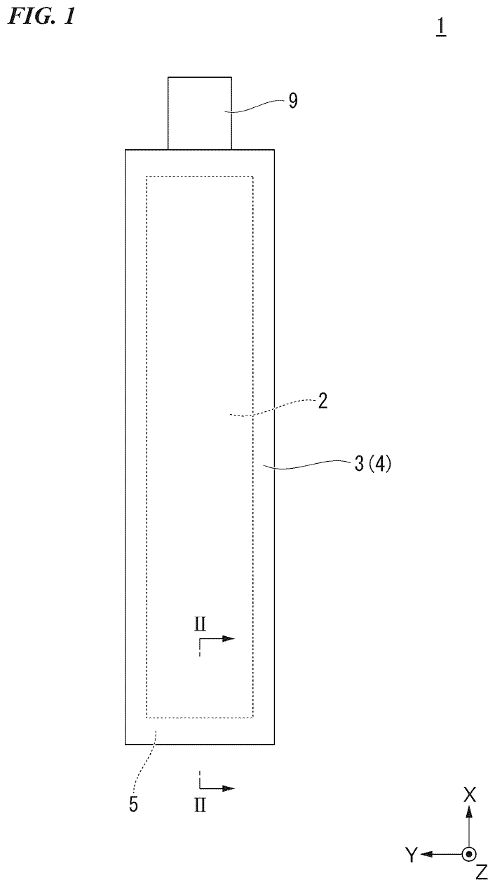

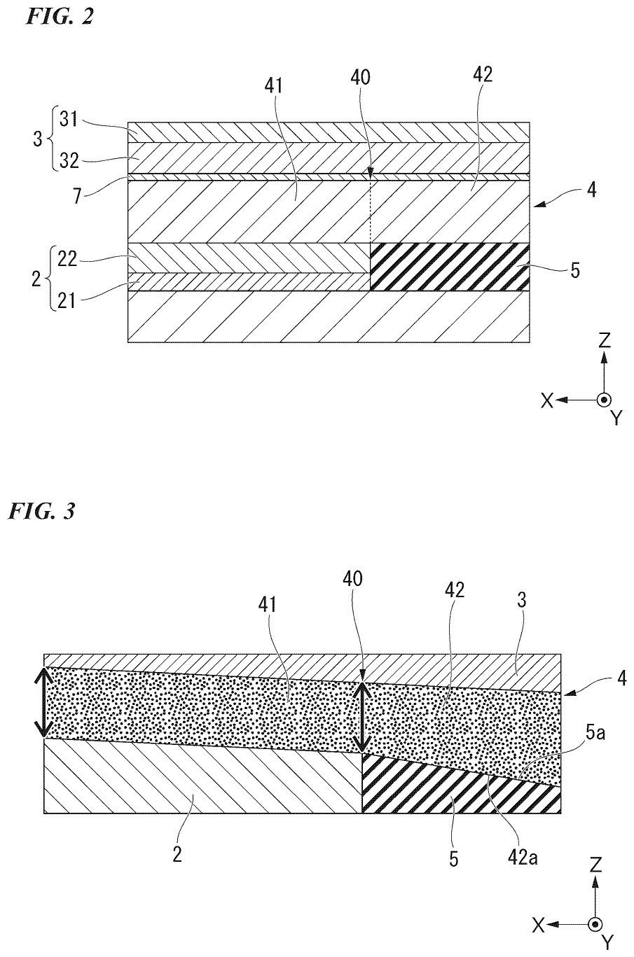

FIG. 1 is a plan view illustrating an all-solid-state battery 1 according to an embodiment. FIG. 2 is a cross-sectional view taken along line II-II of FIG. 1.

Referring to both FIGS. 1 and 2, the all-solid-state battery 1 includes a positive electrode layer 2, a negative electrode layer 3, a solid electrolyte layer 4 disposed between the positive electrode layer 2 and the negative electrode layer 3, and an insulating layer 5 (an insulating frame) disposed on an outer periphery of the positive electrode layer 2.

In the following description, an orthogonal coordinate system of X, Y, and Z will be used, as necessary. An X direction corresponds to a depth direction (longitudinal direction) of the all-solid-state battery 1. A Y direction corresponds to a width direction (short direction) of the all-solid-state battery 1. A Z direction corresponds to the thickness direction of the all-solid-state battery 1. In the following description, in the X direction, the Y direction, and the Z direction, an arrow in the drawing will indicate a plus (+) side, and a side opposite to the arrow will be referred to as a minus (−) side. A +Z side corresponds to an upper side in a vertical direction, and a −Z side corresponds to a lower side in the vertical direction.

A plurality of positive electrode layers 2, insulating layers 5, solid electrolyte layers 4, and negative electrode layers 3 are laminated in the Z direction to form an electrode laminate. The all-solid-state battery 1 includes an exterior material (not illustrated) that houses the electrode laminate. The exterior material is formed of, for example, a laminate film or the like.

The positive electrode layer 2 includes a positive electrode current collector 21 and a positive electrode active material layer 22. Examples of a material of the positive electrode current collector 21 include aluminum. The positive electrode active material layer 22 contains a positive electrode active material. Examples of the positive electrode active material include lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), Li—Mn spinel substituted with a different element represented by Li₁₊ₓMn_{2-x-y}M_{y}O₄ (x+y=2, M=at least one selected from Al, Mg, Co, Fe, Ni, and Zn), lithium titanate (oxide containing Li and Ti), and lithium metal phosphate (LiMPO₄, M=at least one selected from Fe, Mn, Co, and Ni). The positive active material layer 22 may contain various additives such as a binder and a conduction aid.

The negative electrode layer 3 includes a negative electrode current collector 31 and a negative electrode active material layer 32. Examples of a material of the negative electrode current collector 31 include copper. The negative electrode active material layer 32 contains a negative electrode active material. Examples of the negative electrode active material include lithium or a metal that forms an alloy with lithium. Examples of the metal that forms an alloy with lithium include Mg, Si, Au, Ag, In, Ge, Sn, Pb, Al, and Zn. The negative electrode active material may contain a carbonaceous material. Examples of the carbonaceous material include natural graphite, artificial graphite, mesocarbon microbeads (MCMB), hard carbon, and soft carbon.

The solid electrolyte layer 4 includes a solid electrolyte. Examples of the solid electrolyte include a sulfide-based solid electrolyte. Examples of the sulfide-based solid electrolyte include Li₂S—P₂S₅, Li₂S—P₂S₅—LiI, Li₂S—P₂S₅—Li₂O, Li₂S—P₂S₅—Li₂O—LiI, LiS—SiS₂, Li₂S—SiS₂—Li, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and Z is any of Ge, Zn, and Ga.), LizS-GeS₂, LizS-SiS₂—Li₃PO₄, and Li₂S—SiS₂-LixMOy (where x and y are positive numbers, and M is any of P, Si, Ge, B, Al, Ga, and In).

The thickness (the maximum thickness in the Z direction) of the solid electrolyte layer 4 is preferably, for example, 15 μm or more and 300 μm or less. The thickness of the solid electrolyte layer 4 is more preferably 15 μm or more and 150 μm or less, and still more preferably 15 μm or more and 20 μm or less. Note that the thickness of the solid electrolyte layer 4 is not limited to the above, and can be changed according to design specifications.

The insulating layer 5 is disposed so as to cover the outer periphery (a side surface) of the positive electrode layer 2. Examples of a material of the insulating layer include resin. Examples of the resin include an ultraviolet curable resin and a thermosetting resin. Examples of the thermosetting resin include polyethylene terephthalate (PET) and an epoxy resin. Other examples of the material of the insulating layer 5 include polypropylene (PP), polytetrafluoroethylene (PTFE), and rubber (natural rubber, synthetic rubber).

The all-solid-state battery 1 includes a current collecting tab 9 extended from the electrode laminate to an outside through an exterior body. The current collecting tab 9 is connected to the positive electrode current collector 21 and the negative electrode current collector 31. The current collecting tab 9 is formed of, for example, a conductive metal sheet or metal plate. The all-solid-state battery 1 is connected to a charger or an electric load via the current collecting tab 9 to charge or discharge the electrode laminate.

It is preferable that the all-solid-state battery 1 utilizes a dissolution and precipitation reaction of lithium. In the present embodiment, an intermediate layer 7 containing particles having a particle size of 0.5 μm or less is provided between the solid electrolyte layer 4 and the negative electrode layer 3. The particle size of the particles can be measured by particle size distribution measurement.

The intermediate layer 7 may improve, for example, uniformity of lithium ions precipitated on the negative electrode layer 3. The intermediate layer 7 may be a layer having electron conductivity and having voids through which lithium ions can pass. The intermediate layer 7 may contain a substance having lithium metal conductivity and a substance having electron conductivity. Examples of the substance having the lithium metal conductivity include amorphous carbon particles. Examples of the amorphous carbon particles include carbon blacks such as acetylene black, furnace black, and Ketjen black, coke, activated carbon, CNTs (carbon nanotubes), fullerene, and graphene. Examples of the substance having the electron conductivity include metals. The metal may be particles. Examples of the metal include Ag, Au, Pt, Pd, Si, Al, Bi, Sₙ, Zn, Ga, and In.

The thickness (the maximum thickness in the Z direction) of the intermediate layer 7 is preferably, for example, 0.9 μm or more and 3.3 μm or less. The thickness of the intermediate layer 7 is more preferably 0.9 μm or more and 2.2 μm or less. When the thickness of the intermediate layer 7 is the above lower limit value or more, it is advantageous for diffusion of lithium ions, and a rectifying action can be expected. When the thickness of the intermediate layer 7 is the upper limit value or less, resistance is low.

Note that the thickness of the intermediate layer 7 is not limited to the above, and can be changed according to design specifications.

In the present embodiment, the solid electrolyte layer 4 includes an inner layer portion 41 disposed inside a boundary 40 between the outer periphery of the positive electrode layer 2 and the insulating layer 5 in plan view, and an outer layer portion 42 disposed on an outer periphery of the inner layer portion 41 in plan view and overlapping the insulating layer 5. The outer layer portion 42 has a lower ionic conductivity than the inner layer portion 41. The ionic conductivity of the solid electrolyte layer 4 can be measured by impedance measurement.

In the present embodiment, by controlling the ion conductivity of an outer side portion of the solid electrolyte layer 4, rate characteristics of an entire cell reaction surface are equalized, and current concentration is suppressed. By suppressing the current concentration, the deterioration of the cycle characteristics of the all-solid-state battery 1 can be suppressed. Hereinafter, a constitution for suppressing the deterioration of the cycle characteristics of the all-solid-state battery 1 will be described as an example.

FIG. 3 is a cross-sectional view illustrating a first example for suppressing the deterioration of the cycle characteristics.

As illustrated in FIG. 3, the insulating layer 5 preferably has an inclination 5a such that the thickness becomes smaller toward an outside from the boundary 40. The insulating layer 5 is inclined so as to be lowered toward an outer end portion in the −X direction (an outer side in a plane direction orthogonal to a lamination direction). Due to this inclination 5a, the outer layer portion 42 after pressing has a low density. The outer layer portion 42 is formed of a same material as the solid electrolyte layer 4, and after pressing, the thickness becomes larger toward an outer end side than that before pressing, so that the density decreases.

The outer layer portion 42 has an inclination 42a so as to increase in thickness from the boundary 40 toward the outside along the inclination 5a of the insulating layer 5. The outer layer portion 42 is inclined such that the thickness gradually increases from the boundary 40 toward a −X side. In the outer layer portion 42, a surface (a lower surface) facing the insulating layer 5 is inclined more steeply than a surface (an upper surface) facing the negative electrode layer 3.

The inner layer portion 41 may have a constant thickness from the boundary 40 toward a +X side. In the inner layer portion 41, a surface (an upper surface) facing the negative electrode layer 3 and a surface (a lower surface) facing the insulating layer 5 may be disposed in parallel. In the inner layer portion 41, the thickness at the boundary (a vertical distance illustrated in FIG. 3) and the thickness at a portion on the +X side of the boundary 40 (a vertical distance illustrated in FIG. 3) may be the same.

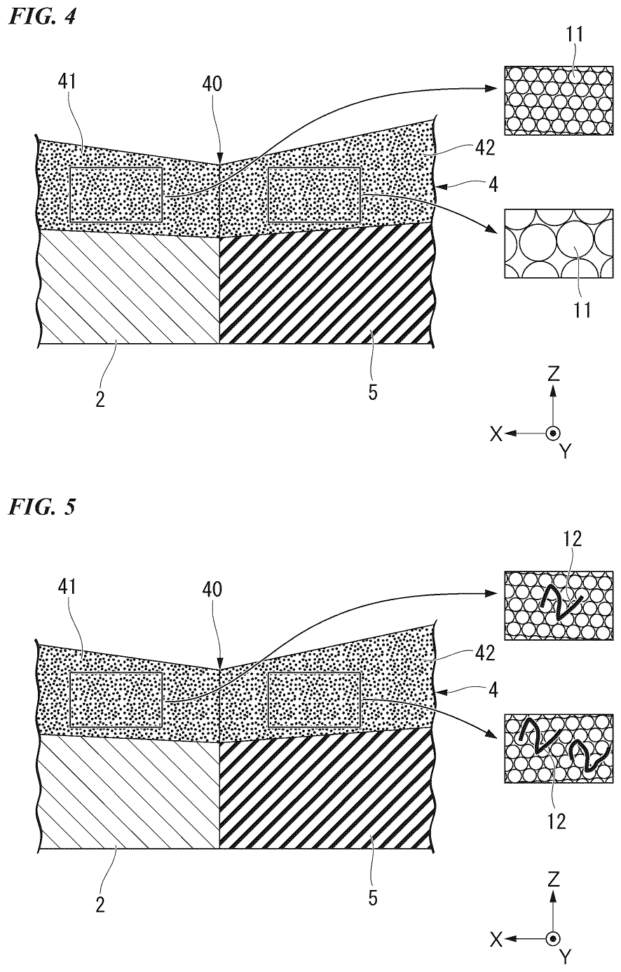

FIG. 4 is a cross-sectional view illustrating a second example for suppressing the deterioration of the cycle characteristics.

As illustrated in FIG. 4, the outer layer portion 42 preferably includes solid electrolyte particles 11 having a particle size larger than that of the inner layer portion 41. The particle size of the solid electrolyte particles 11 can be measured by particle size distribution measurement.

Since the outer layer portion 42 contains the solid electrolyte particles 11 having a particle size larger than that of the inner layer portion 41, a contact area between the solid electrolyte particles 11 is reduced in the outer layer portion 42 of the solid electrolyte layer 4. In other words, in the outer layer portion 42 of solid electrolyte layer 4, a gap formed between the solid electrolyte particles 11 becomes large.

The outer layer portion 42 preferably does not contain the solid electrolyte particles 11 having a particle size of 1 μm or less. The outer layer portion 42 preferably contains the solid electrolyte particles 11 having a particle size of more than 1 μm. As a result, since the solid electrolyte particles 11 contained in the outer layer portion 42 are only coarse particles, the ionic conductivity is lowered in the outer layer portion 42 of the solid electrolyte layer 4.

The density of the outer layer portion 42 may be less than 1.90 g/cm³. The density of the solid electrolyte layer 4 can be measured by a BET method. When the density of the outer layer portion 42 is less than 1.90 g/cm³, the contact area between the solid electrolyte particles 11 decreases, so that the ionic conductivity decreases in the outer layer portion 42 of the solid electrolyte layer 4.

The inner layer portion 41 preferably does not contain the solid electrolyte particles 11 having a particle size of more than 1 μm. The inner layer portion 41 preferably contains the solid electrolyte particles 11 having a particle size of 1 μm or less. As a result, since the solid electrolyte particles 11 contained in the inner layer portion 41 are only fine particles, the ionic conductivity is improved in the inner layer portion 41 of the solid electrolyte layer 4.

The inner layer portion 41 may have a density of 1.90 g/cm3 or more. As a result, the contact area between the solid electrolyte particles 11 increases, so that the ionic conductivity is improved in the inner layer portion 41 of the solid electrolyte layer 4. Further, mechanical strength (for example, tensile strength) is improved in the inner layer portion 41 of the solid electrolyte layer 4.

FIG. 5 is a cross-sectional view illustrating a third example for suppressing the deterioration of the cycle characteristics.

As illustrated in FIG. 5, solid electrolyte layer 4 preferably contains a binder 12. The binder 12 is not particularly limited, and those contained in a solid electrolyte layer 4 of a general solid-state secondary battery can be used. The outer layer portion 42 preferably has a larger amount of the binder 12 than the inner layer portion 41.

In the outer layer portion 42, the amount of the binder 12 relative to a total weight (100 wt %) of the solid electrolyte layer 4 is preferably 3 wt % or more. In the outer layer portion 42, the amount of the binder 12 relative to the total weight (100 wt %) of the solid electrolyte layer 4 is more preferably 20 wt % or more, still more preferably 30 wt %.

In the inner layer portion 41, the amount of the binder 12 relative to the total weight (100 wt %) of the solid electrolyte layer 4 is preferably less than 3 wt %. In the inner layer portion 41, the amount of the binder 12 relative to the total weight (100 wt %) of the solid electrolyte layer 4 may be 1 wt % or less, or 0.1 wt % or less.

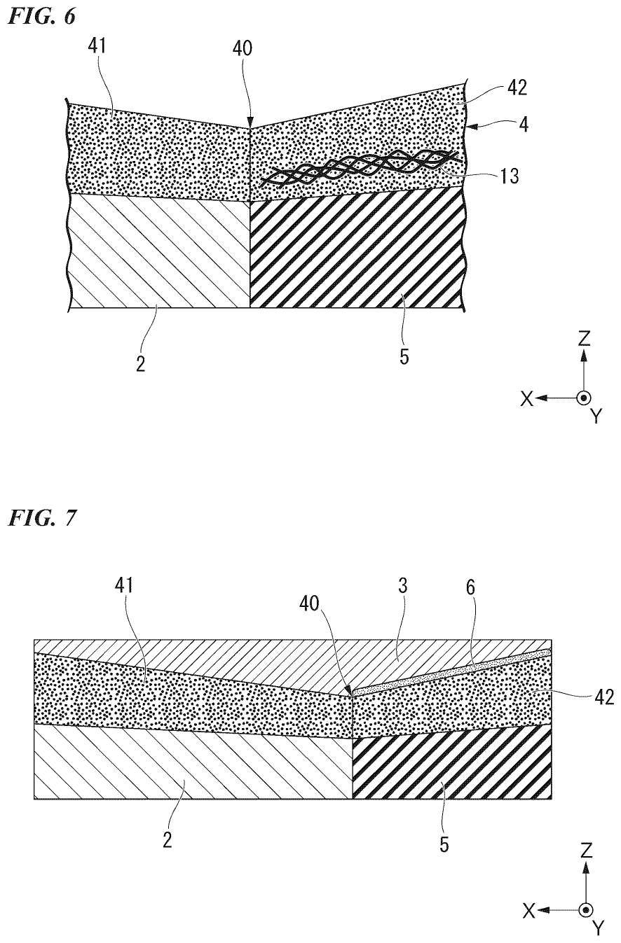

FIG. 6 is a cross-sectional view illustrating a fourth example for suppressing the deterioration of the cycle characteristics.

As illustrated in FIG. 6, the outer layer portion 42 preferably contains an insulating base material 13. The insulating base material 13 may be a sheet or a porous body. Examples of a material of the insulating base material 13 include an organic substance and an inorganic substance. Examples of the organic substance include a resin sheet, a woven fabric, and a nonwoven fabric. Examples of the inorganic substance include a ceramic sheet. Since the nonwoven fabric has many irregularities on a surface and has high affinity with the solid electrolyte, it is suitable for improving strength of the solid electrolyte layer 4.

In the outer layer portion 42, the amount of the insulating base material 13 relative to the total weight (100 wt %) of the solid electrolyte layer 4 is preferably 3 wt % or more. In the outer layer portion 42, the amount of the insulating base material 13 relative to the total weight (100 wt %) of the solid electrolyte layer 4 is more preferably 20 wt % or more, still more preferably 30 wt %.

In the inner layer portion 41, the amount of the insulating base material 13 relative to the total weight (100 wt %) of the solid electrolyte layer 4 is preferably less than 3 wt %. In the inner layer portion 41, the amount of the insulating base material 13 relative to the total weight (100 wt %) of the solid electrolyte layer 4 may be 1 wt % or less, or 0.1 wt % or less.

FIG. 7 is a cross-sectional view illustrating a fifth example for suppressing the deterioration of the cycle characteristics.

As illustrated in FIG. 7, the all-solid-state battery 1 preferably includes an ion conduction suppressing layer 6 that suppresses ion conduction between the insulating layer 5 and the outer layer portion 42. For example, before the negative electrode layer 3 is attached, a solvent for forming a film (the ion conduction suppressing layer 6) may be applied to the solid electrolyte layer 4 (the outer layer portion 42) on the insulating layer 5.

The ion conduction suppressing layer 6 has, for example, a function of suppressing conduction of lithium ions. As a result, even when dendrites are generated from the lithium metal of the negative electrode active material layer 32, it is possible to effectively suppress the occurrence of a short circuit due to the dendrites growing while bypassing the outer periphery of the solid electrolyte layer 4.

A material of the ion conduction suppressing layer 6 is not particularly limited, and various materials capable of expressing the above-described function can be adopted. The material of the ion conduction suppressing layer 6 is preferably a material having no lithium ion conductivity. Examples of the material of the ion conduction suppressing layer 6 include a resin material or a rubber material, and an inorganic powder such as glass frit.

The ion conduction suppressing layer 6 is preferably formed between the insulating layer 5 and the outer layer portion 42 from the boundary 40 to an outer end.

The ion conduction suppressing layer 6 may have a constant thickness between the insulating layer 5 and the outer layer portion 42 from the boundary 40 to the outer end. The thickness of the ion conduction suppressing layer 6 may be half or less of the thickness of the negative electrode layer 3 (the maximum thickness in the Z direction).

Note that the constitution for suppressing the deterioration of the cycle characteristics may include at least one of the first to fifth examples described above. The constitution for suppressing the deterioration of the cycle characteristics more preferably includes at least two constitutions from the first to fifth examples described above, and still more preferably includes at least three or more constitutions from the first to fifth examples described above. As the constitution for suppressing the deterioration of the cycle characteristics, it is most preferable to combine all of the first to fifth examples described above. The aspect of combining the first to fifth examples can be changed according to design specifications.

### Description of Comparative Example

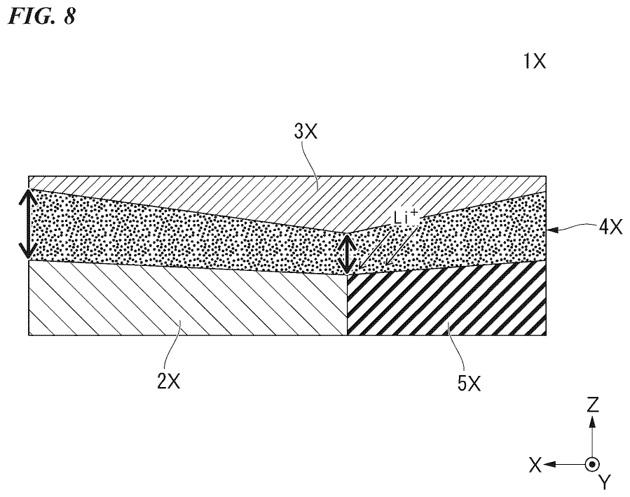

FIG. 8 is a cross-sectional view illustrating an all-solid-state battery 1X according to a comparative example.

As illustrated in FIG. 8, the all-solid-state battery 1X according to the comparative example includes an insulating layer 5X (an insulating frame) disposed on an outer periphery of a positive electrode layer 2X. In the comparative example, in a vicinity of an −X end portion of the positive electrode layer 2X, the thickness of a negative electrode layer 3X is larger and the thickness of a solid electrolyte layer 4X is smaller than that in a central portion (an inner side in a plane direction orthogonal to a lamination direction). In the case of the comparative example, a vicinity of a boundary between an outer periphery of the positive electrode layer 2X and the insulating layer 5X has a lower resistance than a periphery and tends to allow a current to pass therethrough, and is a portion where reaction variation occurs. In the vicinity of the above boundary, since the thickness of the solid electrolyte layer 4X is smaller than that of the periphery, the density becomes high, ionic conductivity is high, the current is concentrated more than other regions, and the deterioration is accelerated. In the deterioration acceleration portion, cycle characteristics may be deteriorated.

The negative electrode layer 3X and the solid electrolyte layer 4X overlapping with the insulating layer 5X in plan view are regions that should not be charged and discharged because they are above the insulating layer 5X. However, since the solid electrolyte layer 4X is connected in the plane direction, for example, lithium ions (Li+) can be conducted and also be diffused in oblique directions (arrow directions) illustrated in FIG. 8. In the solid electrolyte layer 4X, particularly in a region where the ionic conductivity is high, lithium ions move, and lithium can be precipitated.

According to the present constitution as compared with the comparative example, as illustrated in FIG. 3 and the like, in the constitution in which the insulating layer 5 is provided on the outer periphery of the positive electrode layer 2, since the ionic conductivity of the outer layer portion 42 of the solid electrolyte layer 4 is lower than that of the inner layer portion 41, it is possible to suppress reaction variation (in-plane resistance variation) in the vicinity of the boundary 40 between the outer periphery of the positive electrode layer 2 and the insulating layer 5. As a result, it is possible to suppress occurrence of cracks and the precipitation of lithium in the vicinity of the boundary 40 between the outer periphery of the positive electrode layer 2 and the insulating layer 5. Therefore, in the constitution in which the insulating layer 5 is provided on the outer periphery of the positive electrode layer 2, the deterioration of the cycle characteristics is suppressed, and this contributes to stabilization of battery performance.

### Operation and Effects

As described above, the all-solid-state battery 1 of the above embodiment includes the positive electrode layer 2, the negative electrode layer 3, the solid electrolyte layer 4 disposed between the positive electrode layer 2 and the negative electrode layer 3, and the insulating layer 5 (the insulating frame) disposed on the outer periphery of the positive electrode layer 2. The solid electrolyte layer 4 includes the inner layer portion 41 disposed inside the boundary 40 between the outer periphery of the positive electrode layer 2 and the insulating layer 5 in plan view, and the outer layer portion 42 disposed on the outer periphery of the inner layer portion 41 in plan view and overlapping the insulating layer 5. The outer layer portion 42 has a lower ionic conductivity than the inner layer portion 41.

According to this constitution, in the constitution in which the insulating layer 5 is provided on the outer periphery of the positive electrode layer 2, since the ionic conductivity of the outer layer portion 42 of the solid electrolyte layer 4 is lower than that of the inner layer portion 41, it is possible to suppress reaction variation (in-plane resistance variation) in the vicinity of the boundary 40 between the outer periphery of the positive electrode layer 2 and the insulating layer 5. That is, by controlling the ion conductivity of the outer side portion of the solid electrolyte layer 4, the rate characteristics of the entire cell reaction surface can be equalized, and current concentration can be suppressed. Therefore, deterioration of cycle characteristics can be suppressed. Consequently, the present invention contributes to energy efficiency.

In the above embodiment, the insulating layer 5 has the inclination 5a such that the thickness becomes smaller toward the outside from the boundary 40.

According to this constitution, since the insulating layer 5 is inclined so as to be lowered toward the outer end portion, the density of the outer layer portion 42 after pressing becomes low. The outer layer portion 42 is formed of a same material as the solid electrolyte layer 4, and after pressing, the thickness becomes larger toward an outer end side than that before pressing, so that the density decreases. In addition, the positive electrode layer 2 and the insulating layer 5 are different from each other in physical properties (for example, mechanical properties). Even in consideration of disposing the solid electrolyte layer 4 on each of the layers and pressing the solid electrolyte layer 4, the outer layer portion 42 has a lower density toward the outer end side as the insulating layer 5 is inclined so as to be lower toward the outer end portion. As a result, the ionic conductivity decreases toward the outer end side of the outer layer portion 42. Therefore, an electrode reaction outside a positive electrode area (a region outside the portion overlapping the positive electrode layer 2 in plan view, in other words, a region overlapping the outer layer portion 42 in plan view) can be suppressed.

In the above embodiment, the outer layer portion 42 contains the solid electrolyte particles 11 having a particle size larger than that of the inner layer portion 41. According to this constitution, in the outer layer portion 42 of the solid electrolyte layer 4, the contact area between the solid electrolyte particles 11 is reduced, so that the ionic conductivity can be further reduced.

In the above embodiment, the solid electrolyte layer 4 contains the binder 12. The outer layer portion 42 has a larger amount of the binder 12 than the inner layer portion 41.

According to this constitution, as compared with the case where the amount of the binder 12 in the outer layer portion 42 is smaller than that in the inner layer portion 41, the ionic conductivity can be further reduced and the mechanical strength can be improved in the outer layer portion 42 of the solid electrolyte layer 4.

In the above embodiment, the outer layer portion 42 contains the insulating base material 13.

According to this constitution, as compared with the case where the outer layer portion 42 does not contain the insulating base material 13, in the outer layer portion 42 of the solid electrolyte layer 4, the ionic conductivity can be further reduced, and the mechanical strength can be improved.

In the above embodiment, the ion conduction suppressing layer 6 that suppresses the conduction of ions is provided between the insulating layer 5 and the outer layer portion 42.

According to this constitution, the ionic conductivity can be further reduced in the outer layer portion 42 of the solid electrolyte layer 4 by the ion conduction suppressing layer 6.

In the above embodiment, the outer layer portion 42 has the inclination 42a such that the thickness increases from the boundary 40 toward the outside along the inclination of the insulating layer 5.

According to this constitution, since the density of the outer layer portion 42 becomes lower toward the outer end side, the ionic conductivity decreases toward the outer end side of the outer layer portion 42. Therefore, the ionic conductivity can be further reduced in the outer layer portion 42 of the solid electrolyte layer 4.

In the above embodiment, the outer layer portion 42 does not contain the solid electrolyte particles 11 having a particle size of 1 μm or less.

According to this constitution, since the solid electrolyte particles 11 contained in the outer layer portion 42 are only coarse particles, the ionic conductivity can be further reduced in the outer layer portion 42 of the solid electrolyte layer 4.

In the above embodiment, in the outer layer portion 42, the amount of the binder 12 relative to the total weight of the solid electrolyte layer 4 is 3 wt % or more. In the inner layer portion 41, the amount of the binder 12 relative to the total weight of the solid electrolyte layer 4 is less than 3 wt %.

According to this constitution, in the outer layer portion 42 of the solid electrolyte layer 4, the ionic conductivity can be further reduced, and the mechanical strength can be improved.

In the above embodiment, in the outer layer portion 42, the amount of the insulating base material 13 relative to the total weight of the solid electrolyte layer 4 is 3 wt % or more. In the inner layer portion 41, the amount of the insulating base material 13 is less than 3 wt % relative to the total weight of the solid electrolyte layer 4. According to this constitution, in the outer layer portion 42 of the solid electrolyte layer 4, the ionic conductivity can be further reduced, and the mechanical strength can be improved.

In the above embodiment, the ion conduction suppressing layer 6 is formed between the insulating layer 5 and the outer layer portion 42 from the boundary 40 to the outer end.

According to this constitution, as compared with the case where the ion conduction suppressing layer 6 is locally formed between the insulating layer 5 and the outer layer portion 42, the ionic conductivity can be further reduced in the outer layer portion 42 of the solid electrolyte layer 4.

In the above embodiment, the intermediate layer 7 containing particles having a particle size of 0.5 μm or less is provided between the solid electrolyte layer 4 and the negative electrode layer 3.

According to this constitution, even when the thickness of the intermediate layer 7 is small and the particle size of the particles contained in the intermediate layer 7 is small, the structure of the intermediate layer 7 can be stabilized by increasing the density of the solid electrolyte layer 4.

### <Modifications>

In the above embodiment, the description has been given with regard to the example in which the outer layer portion contains the solid electrolyte particles having a particle size larger than that of the inner layer portion, but the present invention is not limited thereto. For example, the outer layer portion may not contain the solid electrolyte particles having a particle size larger than that of the inner layer portion. A magnitude relationship of the particle sizes of the solid electrolyte particles in the outer layer portion and the inner layer portion can be changed according to design specifications.

In the above embodiment, the description has been given with regard to the example in which the solid electrolyte layer contains the binder, and the outer layer portion has a larger amount of the binder than the inner layer portion, but the present invention is not limited thereto. For example, the amount of the binder in the outer layer portion may be equal to or less than the amount of the binder in the inner layer portion. For example, the solid electrolyte layer may not contain the binder. A magnitude relationship of the contents of the binder in the outer layer portion and the inner layer portion can be changed according to design specifications.

In the above embodiment, the description has been given with regard to the example in which the outer layer portion contains the insulating base material, but the present invention is not limited thereto. For example, the outer layer portion may not contain the insulating base material. For example, the inner layer portion may contain an insulating base material. The content aspect of the insulating base materials in the outer layer portion and the inner layer portion can be changed according to design specifications.

In the above embodiment, the description has been given with regard to the example in which the ion conduction suppressing layer that suppresses the conduction of ions is provided between the insulating layer and the outer layer portion, but the present invention is not limited thereto. For example, the ion conduction suppressing layer may not be provided between the insulating layer and the outer layer portion. An installation aspect of the ion conduction suppressing layer can be changed in accordance with design specifications.

In the above embodiment, the description has been given with regard to the example in which the outer layer portion has the inclination such that the thickness increases from the boundary toward the outside along the inclination of the insulating layer, but the present invention is not limited thereto. For example, the outer layer portion may not have the inclination such that the thickness increases from the boundary toward the outside along the inclination of the insulating layer. For example, the outer layer portion may have a constant thickness from the boundary toward the outer end. The aspect of inclination of the outer layer portion can be changed in accordance with design specifications.

In the above embodiment, the description has been given with regard to the example in which the outer layer portion does not contain the solid electrolyte particles having a particle size of 1 μm or less, but the present invention is not limited thereto. For example, the outer layer portion may contain the solid electrolyte particles having a particle size of 1 μm or less. A magnitude relationship of the particle sizes of the solid electrolyte particles in the outer layer portion can be changed according to design specifications.

In the above embodiment, the description has been given with respect to the example in which the amount of the binder relative to the total weight of the solid electrolyte layer is 3 wt % or more in the outer layer portion, and the amount of the binder relative to the total weight of the solid electrolyte layer is less than 3 wt % in the inner layer portion, but the present invention is not limited thereto. For example, in the outer layer portion, the amount of the binder relative to the total weight of the solid electrolyte layer may be less than 3 wt %. For example, in the inner layer portion, the amount of the binder relative to the total weight of the solid electrolyte layer may be 3 wt % or more. A magnitude relationship of the contents of the binder in the outer layer portion and the inner layer portion can be changed according to design specifications.

In the above embodiment, the description has been given with respect to the example in which the amount of the insulating base material relative to the total weight of the solid electrolyte layer is 3 wt % or more in the outer layer portion, and the amount of the insulating base material relative to the total weight of the solid electrolyte layer is less than 3 wt % in the inner layer portion, but the present invention is not limited thereto. For example, in the outer layer portion, the amount of the insulating base material relative to the total weight of the solid electrolyte layer may be less than 3 wt %. For example, in the inner layer portion, the amount of the insulating base material relative to the total weight of the solid electrolyte layer may be 3 wt % or more. The content aspect of the insulating base materials in the outer layer portion and the inner layer portion can be changed according to design specifications.

In the above embodiment, the description has been given with respect to the example in which the ion conduction suppressing layer is formed between the insulating layer and the outer layer portion from the boundary to the outer end, but the present invention is not limited thereto. For example, the ion conduction suppressing layer may be locally formed between the insulating layer and the outer layer portion. The formation aspect of the ion conduction suppressing layer can be changed in accordance with design specifications.

In the above embodiment, the description has been given with respect to the example in which the intermediate layer containing particles having a particle size of 0.5 μm or less is provided between the solid electrolyte layer and the negative electrode layer, but the present invention is not limited thereto. For example, the intermediate layer containing particles having a particle size of 0.5 μm or less may not be provided between the solid electrolyte layer and the negative electrode layer. For example, the intermediate layer may not contain particles having a particle size of 0.5 μm or less. The installation aspect of the intermediate layer can be changed in accordance with design specifications.

Heretofore, the aspects for carrying out the present invention have been described with embodiments, but the present invention is not limited to the embodiments described above, and various modifications and substitutions can be made without departing from the gist of the present invention.

What is claimed is:

1. An all-solid-state battery comprising:
a positive electrode layer;
a negative electrode layer;
a solid electrolyte layer disposed between the positive electrode layer and the negative electrode layer; and
an insulating layer disposed on an outer periphery of the positive electrode layer, wherein
the solid electrolyte layer includes:
an inner layer portion disposed inside a boundary between the outer periphery of the positive electrode layer and the insulating layer in plan view; and
an outer layer portion disposed on an outer periphery of the inner layer portion in the plan view and overlapping the insulating layer, and
the outer layer portion has a lower ionic conductivity than the inner layer portion.

2. The all-solid-state battery according to claim 1, wherein the insulating layer has an inclination such that a thickness becomes smaller toward an outside from the boundary.

3. The all-solid-state battery according to claim 1, wherein the outer layer portion includes solid electrolyte particles having a particle size larger than that of the inner layer portion.

4. The all-solid-state battery according to claim 1, wherein the solid electrolyte layer contains a binder, and
the outer layer portion has a larger amount of the binder than the inner layer portion.

5. The all-solid-state battery according to claim 1, wherein the outer layer portion contains an insulating base material.

6. The all-solid-state battery according to claim 1, further comprising an ion conduction suppressing layer that suppresses conduction of ions between the insulating layer and the outer layer portion.

7. The all-solid-state battery according to claim 2, wherein the outer layer portion has an inclination such that a thickness of the outer layer portion increases toward the outside from the boundary along the inclination of the insulating layer.

8. The all-solid-state battery according to claim 3, wherein the outer layer portion does not contain the solid electrolyte particles having a particle size of 1 μm or less.

9. The all-solid-state battery according to claim 4, wherein
an amount of the binder in the outer layer portion is 3 wt % or more relative to a total weight of the solid electrolyte layer, and
an amount of the binder in the inner layer portion is less than 3 wt % relative to the total weight of the solid electrolyte layer.

10. The all-solid-state battery according to claim 5, wherein
an amount of the insulating base material in the outer layer portion relative to the total weight of the solid electrolyte layer is 3 wt % or more, and
an amount of the insulating base material in the inner layer portion relative to the total weight of the solid electrolyte layer is less than 3 wt %.

11. The all-solid-state battery according to claim 6, wherein the ion conduction suppressing layer is formed between the insulating layer and the outer layer portion from the boundary to an outer end.

12. The all-solid-state battery according to claim 1, further comprising an intermediate layer containing particles having a particle size of 0.5 μm or less between the solid electrolyte layer and the negative electrode layer.
